(19) United States
(12) Patent Application Publication
(10) Pub. No.: US 2025/0284361 A1
(43) Pub. Date: Sep. 11, 2025

(54) ELECTRONIC DEVICE

(71) Applicant: Samsung Display Co., Ltd., Yongin-si (KR)

(72) Inventors: Minjee KIM, Yongin-si (KR); SUNG-KI JUNG, Yongin-si (KR)

(21) Appl. No.: 19/034,411

(22) Filed: Jan. 22, 2025

(30) Foreign Application Priority Data
Mar. 8, 2024 (KR) 10-2024-0033069

(51) Int. Cl. G06F 3/041; G06F 1/16

(52) U.S. Cl. CPC G06F 3/04164; G06F 1/1616; G06F 1/1643; G06F 2203/04102; G06F 2203/04106

(57) ABSTRACT

Disclosed is an electronic device including a display panel, a first digitizer under the display panel, a second digitizer under the display panel, electrically connected to the first digitizer, and including a main part spaced apart from the first digitizer in a first direction, and a connecting part extending from the main part toward the first digitizer to overlap the first digitizer, and a connecting circuit film under the first digitizer.

### CROSS-REFERENCE TO RELATED APPLICATION

The present application claims priority to, and the benefit of, Korean Patent Application No. 10-2024-0033069, filed on Mar. 8, 2024, in the Korean Intellectual Property Office, the entire disclosure of which is incorporated herein by reference.

### BACKGROUND

Embodiments of the present disclosure described herein relate to an electronic device for sensing an input by a pen.

Multimedia electronic devices, such as televisions, mobile phones, tablet computers, notebook computers, car navigation units, game machines, and the like, include a display device for displaying an image. The electronic devices may include a sensor layer (or, an input sensor) capable of providing a touch-based input method that enables a user to intuitively and conveniently input information or instructions in an easy and simple manner, in addition to a conventional input method such as a button, a keyboard, a mouse, or the like. The sensor layer may sense the user's touch or pressure. Meanwhile, pens for users accustomed to inputting information using writing instruments or pens for accurate touch inputs in specific application programs (e.g., application programs for sketching or drawing) have been increasingly demanded.

### SUMMARY

Embodiments of the present disclosure provide an electronic device for sensing an input by a pen.

According to one or more embodiments, an electronic device includes a display panel, a first digitizer under the display panel, a second digitizer under the display panel, electrically connected to the first digitizer, and including a main part spaced apart from the first digitizer in a first direction, and a connecting part extending from the main part toward the first digitizer to overlap the first digitizer, and a connecting circuit film under the first digitizer.

The display panel may include a first non-folding area, a folding area, and a second non-folding area sequentially arranged in the first direction, wherein the first digitizer overlaps the first non-folding area, wherein the main part of the second digitizer overlaps the second non-folding area, and wherein the connecting part overlaps the folding area and the first non-folding area.

The electronic device may further include a connecting film including an anisotropic conductive film between the connecting part and the first digitizer for electrically connecting the first digitizer and the second digitizer.

In a first state in which the folding area of the display panel has a flat shape, a length of the connecting part between an edge of the connecting part and a boundary between the main part and the connecting part may be greater than or equal to a distance between the boundary and the edge in plan view.

At least a portion of the connecting part may have a curved shape in the first state.

The distance may be in a direction parallel to the first direction.

The electronic device may further include a conductive film between the connecting circuit film and the first digitizer, wherein the connecting circuit film is electrically connected with the first digitizer, and is electrically connected with the main part of the second digitizer, through the first digitizer and the connecting part.

The electronic device may further include a bridge circuit film electrically connected to the connecting circuit film, a first connector at one end of the bridge circuit film, and connected with the connecting circuit film, and a second connector at an opposite end of the bridge circuit film.

The first digitizer may include first pads electrically connected to the connecting circuit film, wherein the second digitizer includes second pads electrically connected to the first digitizer.

An extension direction of a folding axis of the display panel may be substantially the same as an arrangement direction of the second pads.

An arrangement direction of the first pads may be substantially the same as an arrangement direction of the second pads.

An arrangement direction of the first pads may cross an arrangement direction of the second pads.

The first digitizer and the second digitizer may be spaced apart from each other in the first direction, wherein a width of the connecting part in a second direction crossing the first direction is less than a width of the main part.

The electronic device may include a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).

According to one or more embodiments, an electronic device includes a display panel including a first non-folding area, a folding area, and a second non-folding area sequentially arranged in a first direction, a first digitizer overlapping the first non-folding area and at least a portion of the folding area, and a second digitizer including a main part overlapping the second non-folding area, and a connecting part extending from the main part and overlapping the first digitizer.

In a first state in which the folding area of the display panel has a flat shape, a length of the connecting part between an edge of the connecting part and a boundary between the main part and the connecting part may be greater than or equal to a distance in the first direction between the boundary and the edge.

At least a portion of the connecting part may have a curved shape in the first state.

The electronic device may further include a connecting circuit film coupled to the first digitizer, wherein the first digitizer includes first pads electrically connected to the connecting circuit film, wherein the second digitizer is electrically connected to the connecting circuit film through the first digitizer, and includes second pads electrically connected to the first digitizer, and wherein an extension direction of a folding axis of the display panel is substantially the same as an arrangement direction of the second pads.

An arrangement direction of the first pads may be substantially the same as the arrangement direction of the second pads.

An arrangement direction of the first pads may cross the arrangement direction of the second pads.

The electronic device may further include a bridge circuit film electrically connected to the connecting circuit film, a first connector at one end of the bridge circuit film, and connected with the connecting circuit film, and a second connector at an opposite end of the bridge circuit film.

### BRIEF DESCRIPTION OF THE DRAWINGS

The above and other aspects of the present disclosure will become apparent by describing in detail embodiments thereof with reference to the accompanying drawings.

FIG. 1A is a perspective view of an electronic device according to one or more embodiments of the present disclosure.

FIG. 1B is a rear perspective view of the electronic device according to one or more embodiments of the present disclosure.

FIG. 2 is a sectional view of the electronic device according to one or more embodiments of the present disclosure.

FIG. 3 is a schematic sectional view of a display panel according to one or more embodiments of the present disclosure.

FIG. 4 is a view for explaining an operation of the electronic device according to one or more embodiments of the present disclosure.

FIG. 5 is a view illustrating some components of the electronic device according to one or more embodiments of the present disclosure.

FIG. 6 is a sectional view of a portion of a digitizer according to one or more embodiments of the present disclosure.

FIG. 7 is a sectional view of a portion of a digitizer according to one or more embodiments of the present disclosure.

FIG. 8 is a sectional view illustrating some components of the electronic device in a state in which the display panel is flat according to one or more embodiments of the present disclosure.

FIG. 9 is a sectional view illustrating some components of the electronic device in a state in which the display panel is folded according to one or more embodiments of the present disclosure.

FIG. 10 is a view illustrating some components of the electronic device according to one or more embodiments of the present disclosure.

FIG. 11 is a view illustrating some components of the electronic device according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

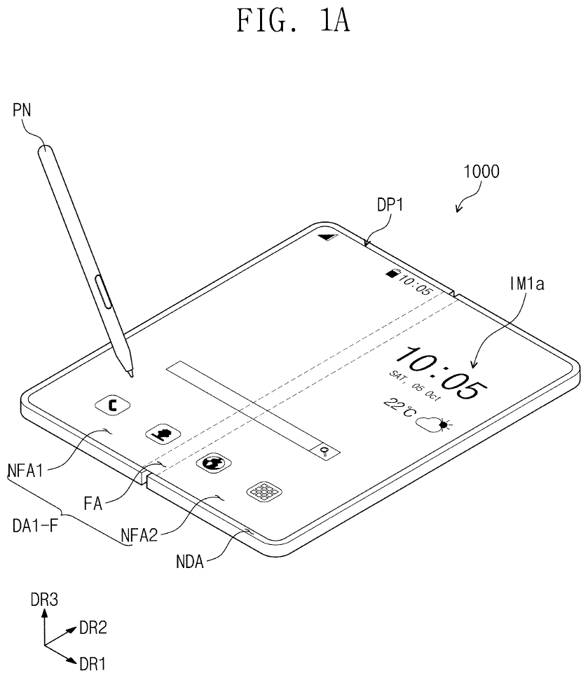

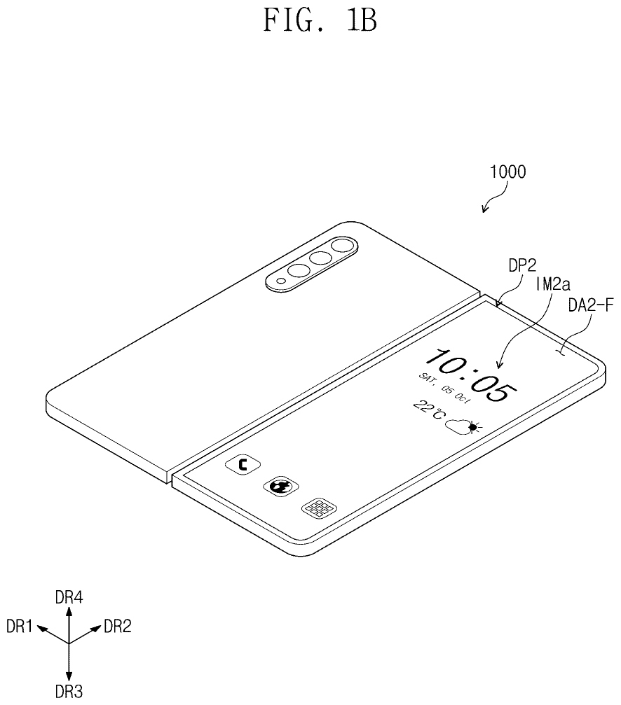

FIG. 1A is a perspective view of an electronic device 1000 according to one or more embodiments of the present disclosure. FIG. 1B is a rear perspective view of the electronic device 1000 according to one or more embodiments of the present disclosure.

Referring to FIGS. 1A and 1B, the electronic device 1000 may be a device activated depending on an electrical signal. For example, the electronic device 1000 may display an image and may sense an input applied from the outside. The external input may be a user input. The user input may include various types of external inputs such as a part of a user's body, a pen PN, light, heat, or pressure.

The electronic device 1000 may include a first display panel DP1 and a second display panel DP2. The first display panel DP1 and the second display panel DP2 may be separate panels separated from each other. The first display panel DP1 may be referred to as a main display panel, and the second display panel DP2 may be referred to as an auxiliary display panel or an external display panel. According to one or more embodiments of the present disclosure, at least one of the first display panel DP1 or the second display panel DP2 may sense an input by the pen PN.

The first display panel DP1 may include a first display part DA1-F, and the second display panel DP2 may include a second display part DA2-F. The second display panel DP2 may have a smaller area than the first display panel DP1. The first display part DA1-F and the second display part DA2-F may have areas corresponding to the sizes of the first display panel DP1 and the second display panel DP2, respectively, and the first display part DA1-F may have a larger area than the second display part DA2-F.

In an unfolded state of the electronic device 1000, the first display part DA1-F may have a plane substantially parallel to a first direction DR1 and to a second direction DR2. The thickness direction of the electronic device 1000 may be parallel to a third direction DR3 that crosses the first direction DR1 and the second direction DR2. Accordingly, front surfaces (or, upper surfaces) and rear surfaces (or, lower surfaces) of members constituting the electronic device 1000 may be defined based on the third direction DR3.

The first display panel DP1 or the first display part DA1-F may include a folding area FA that is able to be folded and unfolded, and a plurality of non-folding areas NFA1 and NFA2 spaced apart from each other with the folding area FA therebetween. The second display panel DP2 may overlap one of the plurality of non-folding areas NFA1 and NFA2. For example, the second display panel DP2 may overlap the first non-folding area NFA1.

The display direction of a first image IM1a displayed on a portion of the first display panel DP1, for example, the first non-folding area NFA1 may be opposite to the display direction of a second image IM2a displayed on the second display panel DP2. For example, the first image IM1a may be displayed in the third direction DR3, and the second image IM2a may be displayed in a fourth direction DR4 opposite to the third direction DR3.

In one or more embodiments of the present disclosure, the folding area FA may be bent about a folding axis extending in a direction parallel to long sides of the electronic device 1000, for example, in a direction parallel to the second direction DR2. The folding area FA has a corresponding curvature and a corresponding radius of curvature in a folded state of the electronic device 1000. The electronic device 1000 may be folded in an in-folding manner such that the first non-folding area NFA1 and the second non-folding area NFA2 face each other, and such that the first display part DA1-F is not exposed to the outside.

In one or more embodiments of the present disclosure, the electronic device 1000 may be folded in an out-folding manner such that the first display part DA1-F is exposed to the outside. In one or more embodiments of the present disclosure, the electronic device 1000 may be folded in an in-folding or out-folding manner in the unfolded state. However, the present disclosure is not limited thereto.

Although FIG. 1A illustrates an example that one folding area FA is defined in the electronic device 1000, the present disclosure is not limited thereto. For example, a plurality of folding axes and a plurality of folding areas corresponding thereto may be defined in the electronic device 1000, and the electronic device 1000 may be folded about the plurality of folding axes in an in-folding or out-folding manner in the unfolded state.

The electronic device 1000 may be a device that displays a moving image and/or a still image. The display panels DP1 and DP2 may be applied to portable electronic devices, such as mobile phones, smartphones, tablet personal computers (PCs), mobile communication terminals, electronic notebooks, electronic books, portable multimedia players (PMPs), navigations, and ultra-mobile PCs (UMPCs). For example, the display panels DP1 and DP2 may be applied to a display unit of a television, a laptop computer, a monitor, a billboard, or the Internet of Things (IoT). Alternatively, in one or more embodiments, the display panels DP1 and DP2 may be applied to a smartwatch, a watch phone, and/or a head-mounted display device (HMD) for implementing virtual reality and/or augmented reality.

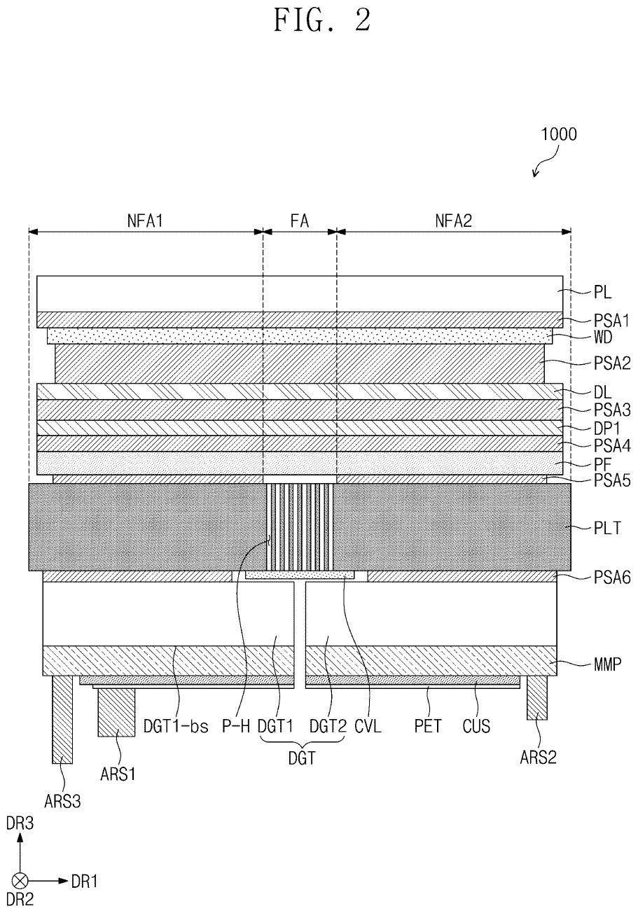

FIG. 2 is a sectional view of the electronic device 1000 according to one or more embodiments of the present disclosure. The sectional view illustrated in FIG. 2 may be a sectional view illustrating a portion of the electronic device 1000 that includes the first display panel DP1 (hereinafter, referred to as the display panel) of the electronic device 1000 illustrated in FIG. 1A.

Referring to FIG. 2, the electronic device 1000 may include the display panel DP1, upper functional layers, and lower functional layers. The upper functional layers may include components located on the display panel DP1, and the lower functional layers may include components located under the display panel DP1.

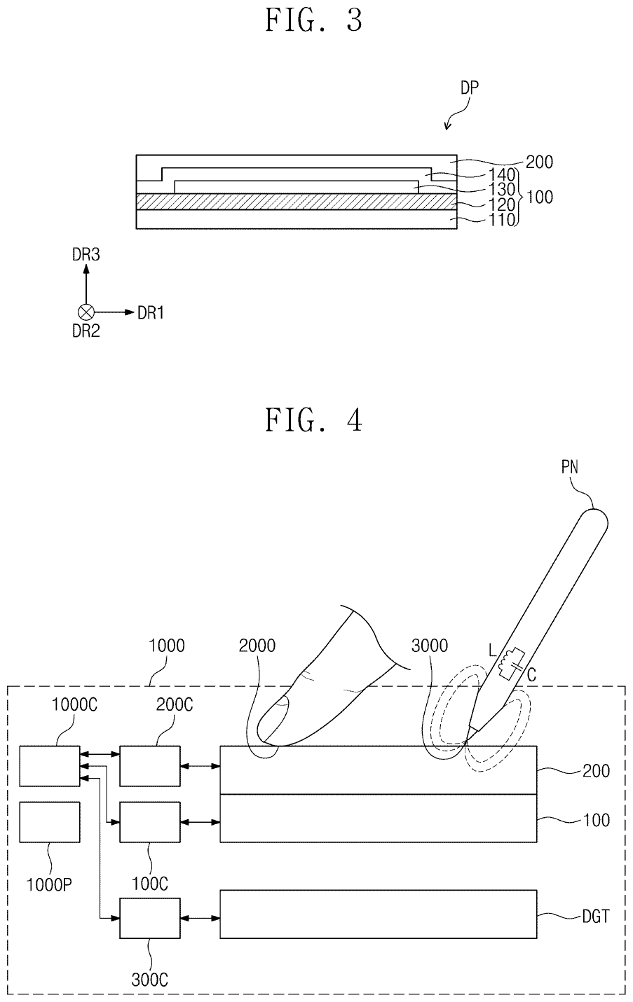

The display panel DP1 may be a component that generates an image, and that senses an input applied from the outside. For example, the display panel DP1 may include a display layer 100 (refer to FIG. 3) and a sensor layer 200 (refer to FIG. 3).

The upper functional layers may include a protective layer PL, a window WD, an impact-absorbing layer DL, and first to third adhesive layers PSA1, PSA2, and PSA3. The components included in the upper functional layers are not limited to the aforementioned components. At least some of the aforementioned components may be omitted, and other components may be added.

The protective layer PL may protect components located under the protective layer PL. The protective layer PL may have a thickness of about 60 μm to about 70 μm, for example, a thickness of about 65 μm. However, the thickness of the protective layer PL is not limited thereto.

A hard coating layer, an anti-fingerprint layer, and the like may be additionally provided to the protective layer PL to improve characteristics, such as chemical resistance, wear resistance, and the like. For example, the hard coating layer may be a functional layer for improving the usage characteristics of the electronic device 1000, and may be provided on the protective layer PL by coating. For example, anti-fingerprint characteristics, anti-contamination characteristics, and anti-scratch characteristics may be improved by the hard coating layer. For example, the hard coating layer may have a thickness of about 5 μm, but is not particularly limited thereto.

The window WD may be located under the protective layer PL. The first adhesive layer PSA1 may be located between the window WD and the protective layer PL. The first adhesive layer PSA1 may have a thickness of about 30 μm to about 40 μm, for example, a thickness of about 35 μm. However, the thickness of the first adhesive layer PSA1 is not limited thereto. In one or more embodiments of the present disclosure, a bezel pattern may be located between the first adhesive layer PSA1 and the protective layer PL.

The window WD may include an optically clear insulating material. For example, the window WD may include a glass substrate or a synthetic resin film. The window WD may have a multi-layer structure or a single-layer structure. For example, the window WD may include a plurality of synthetic resin films coupled through an adhesive, or may include a glass substrate and a synthetic resin film coupled through an adhesive. When the window WD is a glass substrate, the window WD may have a thickness of about 80 μm or less, for example, a thickness of about 30 μm. However, the thickness of the window WD is not limited thereto.

The impact-absorbing layer DL may be located under the window WD. The second adhesive layer PSA2 may be located between the window WD and the impact-absorbing layer DL. The second adhesive layer PSA2 may have a thickness of about 70 μm to about 80 μm, for example, a thickness of about 75 μm. However, the thickness of the second adhesive layer PSA2 is not limited thereto.

The impact-absorbing layer DL may protect the display panel DP1 by absorbing impact applied toward the display panel DP1. The impact-absorbing layer DL may be manufactured in the form of a stretchable film. For example, the impact-absorbing layer DL may include a flexible plastic material. The flexible plastic material may be defined as a synthetic resin film. For example, the impact-absorbing layer DL may include a flexible plastic material, such as polyimide or polyethylene terephthalate. The impact-absorbing layer DL may have a thickness of about 18 μm to about 28 μm, for example, a thickness of about 23 μm. However, the thickness of the impact-absorbing layer DL is not limited thereto. In one or more embodiments of the present disclosure, the impact-absorbing layer DL may be omitted.

The third adhesive layer PSA3 may be located between the impact-absorbing layer DL and the display panel DP1. The third adhesive layer PSA3 may have a thickness of about 45 μm to about 55 μm, for example, a thickness of about 50 μm. However, the thickness of the third adhesive layer PSA3 is not limited thereto.

The lower functional layers may include a protective film PF, a plate PLT, a cover layer CVL, a digitizer DGT, a shielding layer MMP, a lower sheet CUS, an insulating film PET, a step compensation members ARS1, ARS2, and ARS3, and fourth to sixth adhesive layers PSA4, PSA5, and PSA6. The components included in the lower functional layers are not limited to the aforementioned components. At least some of the aforementioned components may be omitted, and other components may be added.

The protective film PF may be coupled to the rear surface of the display panel DP1 through the fourth adhesive layer PSA4. The fourth adhesive layer PSA4 may have a thickness of about 20 μm to about 30 μm, for example, a thickness of about 25 μm. However, the thickness of the fourth adhesive layer PSA4 is not limited thereto.

The protective film PF may reduce or prevent a scratch on the rear surface of the display panel DP1 during a manufacturing process of the display panel DP1. The protective film PF may be a colored polyimide film. For example, the protective film PF may be an opaque yellow film, but is not limited thereto. The protective film PF may have a thickness of about 45 μm to about 55 μm, for example, a thickness of about 50 μm. However, the thickness of the protective film PF is not limited thereto.

The plate PLT may be located under the protective film PF. The fifth adhesive layer PSA5 may be located between the plate PLT and the protective film PF. The fifth adhesive layer PSA5 may have a thickness of about 11 μm to about 21 μm, for example, a thickness of about 16 μm. However, the thickness of the fifth adhesive layer PSA5 is not limited thereto.

The plate PLT may support components located thereon. Openings P-H may be defined (or, formed or provided) in a portion of the plate PLT. For example, the plate PLT may include the openings P-H having a shape penetrating the plate PLT from the upper surface of the plate PLT to the lower surface of the plate PLT. The openings P-H may be defined in an area overlapping the folding area FA. The openings P-H may overlap the folding area FA when viewed from above the plane (e.g., in plan view), for example, when viewed in the third direction DR3 or in the thickness direction of the plate PLT. A portion of the plate PLT may be more easily deformed by the openings P-H. The plate PLT may have a thickness of about 160 μm to about 180 μm, for example, a thickness of about 170 μm. However, the thickness of the plate PLT is not limited thereto.

The plate PLT is located on the digitizer DGT to be described below. Accordingly, the plate PLT may be provided in a form that does not interfere with a signal provided to the digitizer DGT. For example, the plate PLT may include a fiber reinforced composite that is a non-metallic material. In this case, a phenomenon in which a signal is blocked may be reduced or eliminated. For example, the plate PLT may include carbon fiber reinforced plastic (CFRP).

The cover layer CVL may be attached to the plate PLT. The cover layer CVL may cover the openings P-H of the plate PLT. Accordingly, the cover layer CVL may reduce or prevent infiltration of foreign matter into the openings P-H. The cover layer CVL may include thermoplastic polyurethane, but is not particularly limited thereto. The cover layer CVL may have a thickness of about 11 μm to about 21 μm, for example, a thickness of about 16 μm. However, the thickness of the cover layer CVL is not limited thereto.

The digitizer DGT may be located under the plate PLT and the cover layer CVL. The sixth adhesive layer PSA6 may be located between the digitizer DGT and the plate PLT. The sixth adhesive layer PSA6 may have a thickness of about 15 μm to about 25 μm, for example, a thickness of about 20 μm. However, the thickness of the sixth adhesive layer PSA6 is not limited thereto.

The digitizer DGT may receive information about the position of the pen PN (refer to FIG. 1A). For example, the digitizer DGT may be implemented in an electromagnetic type (or, an electromagnetic resonance type). For example, the digitizer DGT may include a plurality of coils. However, without being limited thereto, the digitizer DGT may be implemented in an active electrostatic type.

The digitizer DGT may include a first digitizer DGT1 and a second digitizer DGT2. The first digitizer DGT1 and the second digitizer DGT2 may be located under the display panel DP1. The first digitizer DGT1 may overlap the first non-folding area NFA1, and the second digitizer DGT2 may overlap the second non-folding area NFA2. A gap may be defined between the first digitizer DGT1 and the second digitizer DGT2. The gap may overlap the folding area FA. One portion of the first digitizer DGT1 may overlap one portion of the folding area FA, and one portion of the second digitizer DGT2 may overlap another portion of the folding area FA.

In one or more embodiments of the present disclosure, the first digitizer DGT1 and the second digitizer DGT2 may be directly electrically connected with each other without a separate flexible circuit board. That is, a separate component for connecting the first digitizer DGT1 and the second digitizer DGT2 may be omitted.

Accordingly, a portion of the second digitizer DGT2 may overlap the first digitizer DGT1. Because the component is able to be omitted, the manufacturing cost of the electronic device 1000 may be reduced, and the space in the set may be easily secured.

The shielding layer MMP may be located under the digitizer DGT. The shielding layer MMP may include magnetic metal powder. The shielding layer MMP may be referred to as a ferrite sheet, a magnetic metal powder layer, a magnetic layer, a magnetic circuit layer, or a magnetic path layer. The shielding layer MMP may shield a magnetic field that transmits through the display panel DP1. For example, the shielding layer MMP may serve to induce the transmitted magnetic field in another direction. Accordingly, the magnetic field that reaches the shielding layer MMP may be shielded without being leaked to the outside, for example, below the shielding layer MMP. The shielding layer MMP may have a thickness of about 53 μm to about 63 μm, for example, a thickness of about 58 μm. However, the thickness of the shielding layer MMP is not limited thereto.

The lower sheet CUS may be located under the shielding layer MMP. The lower sheet CUS may be a sheet that serves to reflect a magnetic field toward the shielding layer MMP. The lower sheet CUS may include metal or metal alloy. For example, the lower sheet CUS may include aluminum, copper, or a copper alloy. The lower sheet CUS may have a thickness of about 15 μm to about 25 μm, for example, a thickness of about 20 μm. However, the thickness of the lower sheet CUS is not limited thereto.

The insulating film PET may be located under the lower sheet CUS. The insulating film PET may include polyethylene terephthalate, but is not particularly limited thereto. The insulating film PET may reduce or prevent introduction of static electricity. For example, the insulating film PET may reduce or prevent electrical interference between members located on the insulating film PET and members located under the insulating film PET. The insulating film PET may have a thickness of about 3 μm to about 9 μm, for example, a thickness of about 6 μm. However, the thickness of the insulating film PET is not limited thereto.

The step compensation members ARS1, ARS2, and ARS3 may include the first step compensation member ARS1 attached to the insulating film PET, the second step compensation member ARS2 attached to the shielding layer MMP, and the third step compensation member ARS3 attached to the shielding layer MMP. The thicknesses of the first to third step compensation members ARS1, ARS2, and ARS3 may be diversely set depending on the product structure or an arrangement relationship between components. For example, the first step compensation member ARS1 may have a thickness of about 90 μm, the second step compensation member ARS2 may have a thickness of about 87 μm, and the third step compensation member ARS3 may have a thickness of about 87 μm. However, the present disclosure is not particularly limited thereto.

In one or more embodiments of the present disclosure, the sixth adhesive layer PSA6, the shielding layer MMP, the lower sheet CUS, and the insulating film PET may each have a structure divided at a portion overlapping the folding area FA. For example, the sixth adhesive layer PSA6, the shielding layer MMP, the lower sheet CUS, and the insulating film PET may each be divided into two components spaced apart from each other with a corresponding gap at the portion overlapping the folding area FA. The gap may range from about 0.6 mm to about 1.7 mm, but is not particularly limited thereto.

FIG. 3 is a schematic sectional view of a display panel DP according to one or more embodiments of the present disclosure.

Referring to FIG. 3, the display panel DP may correspond to each of the first display panel DP1 and the second display panel DP2 illustrated in FIG. 1A. The display panel DP may include the display layer 100 and the sensor layer 200.

The display layer 100 may be a component that substantially generates an image. The display layer 100 may be an emissive display layer. For example, the display layer 100 may be an organic light emitting display layer, an inorganic light emitting display layer, an organic-inorganic light emitting display layer, a quantum-dot display layer, a micro-LED display layer, or a nano-LED display layer.

The display layer 100 may include a base layer 110, a circuit layer 120, a light emitting element layer 130, and an encapsulation layer 140.

The base layer 110 may be a member that provides a base surface on which the circuit layer 120 is located. The base layer 110 may have a multi-layer structure or a single-layer structure. The base layer 110 may be a glass substrate, a metal substrate, a silicon substrate, or a polymer substrate, but is not particularly limited thereto.

The circuit layer 120 may be located on the base layer 110. The circuit layer 120 may include an insulating layer, a semiconductor pattern, a conductive pattern, and a signal line. An insulating layer, a semiconductor layer, and a conductive layer may be formed on the base layer 110 by a process, such as coating or deposition and may be selectively subjected to patterning by performing a photolithography process a plurality of times.

The light emitting element layer 130 may be located on the circuit layer 120. The light emitting element layer 130 may include light emitting elements. For example, the light emitting element layer 130 may include an organic luminescent material, an inorganic luminescent material, an organic-inorganic luminescent material, a quantum dot, a quantum rod, a micro LED, or a nano LED.

The encapsulation layer 140 may be located on the light emitting element layer 130. The encapsulation layer 140 may protect the light emitting element layer 130 from foreign matter, such as moisture, oxygen, and dust particles.

The sensor layer 200 may be located on the display layer 100. The sensor layer 200 may sense an external input applied from the outside. The sensor layer 200 may be an integrated sensor continuously formed in a process of manufacturing the display layer 100. Alternatively, the sensor layer 200 may be an external sensor attached to the display layer 100. The sensor layer 200 may be referred to as a sensor, an input sensing layer, an input sensing panel, or an electronic device for sensing input coordinates.

FIG. 4 is a view for explaining an operation of the electronic device 1000 according to one or more embodiments of the present disclosure.

Referring to FIG. 4, the electronic device 1000 may include the display layer 100, the sensor layer 200, the digitizer DGT, a display driver 100C, a sensor driver 200C, a digitizer driver 300C, a main driver 1000C, and a power circuit 1000P.

The sensor layer 200 may sense a first input 2000 applied from the outside. The first input 2000 may be an input by an input means capable of causing a change in the capacitance of the sensor layer 200. For example, the first input 2000 may be an input by a passive input means, such as a part of the user's body.

The digitizer DGT may sense a second input 3000 applied from the outside. The second input 3000 may be an input by an input means capable of causing an induced current in the digitizer DGT. The second input 3000 may be an input by the pen PN or an input by an RFIC tag. For example, the pen PN may be a pen of a passive type or a pen of an active type.

In one or more embodiments of the present disclosure, the pen PN may be a device that generates a magnetic field having a corresponding resonant frequency. The pen PN may be configured to transmit an output signal based on an electromagnetic resonance scheme. The pen PN may be referred to as an input device, an input pen, a magnetic pen, a stylus pen, or an electromagnetic resonance pen.

The pen PN may include an RLC resonance circuit, and the RLC resonance circuit may include an inductor L and a capacitor C. In one or more embodiments of the present disclosure, the RLC resonance circuit may be a variable resonance circuit that varies the resonant frequency. In this case, the inductor L may be a variable inductor, and/or the capacitor C may be a variable capacitor. However, the present disclosure is not particularly limited thereto.

The inductor L generates a current by a magnetic field formed in the electronic device 1000, for example, the digitizer DGT. However, the present disclosure is not particularly limited thereto. For example, when the pen PN operates in an active type, the pen PN may generate a current even though a magnetic field is not provided to the pen PN from the outside. The generated current is transferred to the capacitor C. The capacitor C charges the current input from the inductor L and discharges the charged current to the inductor L. Thereafter, the inductor L may emit a magnetic field having a resonant frequency. An induced current may flow in the sensor layer 200 or the digitizer DGT by the magnetic field emitted from the pen PN. The induced current may be transferred to the sensor driver 200C as a reception signal (or, a sensing signal or a signal).

The main driver 1000C may control overall operation of the electronic device 1000. For example, the main driver 1000C may control operations of the display driver 100C and the sensor driver 200C. The main driver 1000C may include at least one microprocessor, and may also include a graphic controller. The main driver 1000C may be referred to as an application processor, a central processing unit, or a main processor.

The display driver 100C may drive the display layer 100. The display driver 100C may receive image data and a control signal from the main driver 1000C. The control signal may include various signals. For example, the control signal may include an input vertical synchronization signal, an input horizontal synchronization signal, a main clock signal, and a data enable signal.

The sensor driver 200C may drive the sensor layer 200. The sensor driver 200C may receive a control signal from the main driver 1000C. The control signal may include a clock signal of the sensor driver 200C. The digitizer driver 300C may drive the digitizer DGT.

The sensor driver 200C and the digitizer driver 300C may be implemented with integrated circuits (ICs) and may be electrically connected to the sensor layer 200 and the digitizer DGT. For example, the sensor driver 200C and the digitizer driver 300C may be directly mounted on corresponding areas of the display panel. Alternatively, the sensor driver 200C and the digitizer driver 300C may be mounted on separate printed circuit boards using a chip on film (COF) method, and may be electrically connected to the sensor layer 200 and the digitizer DGT.

The sensor driver 200C may calculate coordinate information of an input based on a signal received from the sensor layer 200, and may provide a coordinate signal having the coordinate information to the main driver 1000C. In addition, the digitizer driver 300C may calculate coordinate information of an input based on a signal received from the digitizer DGT, and may provide a coordinate signal having the coordinate information to the main driver 1000C.

The main driver 1000C executes operations corresponding to the inputs, based on the coordinate signals. For example, the main driver 1000C may operate the display driver 100C such that a new application image is displayed on the display layer 100.

The power circuit 1000P may include a power management integrated circuit (PMIC). The power circuit 1000P may generate a plurality of driving voltages for driving the display layer 100, the sensor layer 200, the display driver 100C, and the sensor driver 200C. For example, the plurality of driving voltages may include a gate high-voltage, a gate low-voltage, a first driving voltage (e.g., an ELVSS voltage), a second driving voltage (e.g., an ELVDD voltage), an initialization voltage, and the like, but are not particularly limited to the examples.

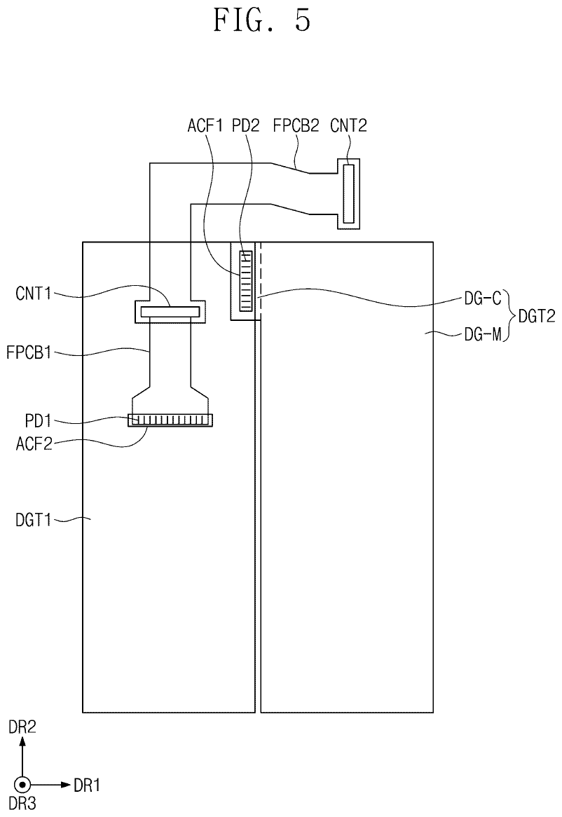

FIG. 5 is a view illustrating some components of the electronic device 1000 (refer to FIG. 2) according to one or more embodiments of the present disclosure.

Referring to FIG. 5, the first digitizer DGT1, the second digitizer DGT2, a connecting circuit film FPCB1, and a bridge circuit film FPCB2 are illustrated.

In one or more embodiments of the present disclosure, the second digitizer DGT2 may be electrically connected to the first digitizer DGT1. For example, the second digitizer DGT2 may include a main part DG-M spaced apart from the first digitizer DGT1 in the first direction DR1, and a connecting part DG-C extending from the main part DG-M toward the first digitizer DGT1 and overlapping the first digitizer DGT1.

The first digitizer DGT1 and the main part DG-M of the second digitizer DGT2 may be spaced apart from each other in the first direction DR1, and the width of the connecting part DG-C in the second direction DR2 crossing the first direction DR1 may be less than the width of the main part DG-M in the second direction DR2.

Although FIG. 5 illustrates an example that one side of the connecting part DG-C that extends in the first direction DR1 is aligned with one side of the main part DG-M that extends in the first direction DR1, the present disclosure is not particularly limited thereto.

The electronic device 1000 may further include a connecting film ACF1 located between the connecting part DG-C and the first digitizer DGT1. The first digitizer DGT1 and the second digitizer DGT2 may be electrically connected through the connecting film ACF1. In one or more embodiments of the present disclosure, the connecting film ACF1 may be an anisotropic conductive film, but is not particularly limited thereto. For example, a conductive layer of the first digitizer DGT1 and a conductive layer of the second digitizer DGT2 may be directly electrically connected with each other.

The electronic device 1000 may further include the connecting circuit film FPCB1 located under the first digitizer DGT1. The connecting circuit film FPCB1 may be coupled to the rear surface DGT1-bs (refer to FIG. 2) of the first digitizer DGT1. A conductive film ACF2 may be located between the connecting circuit film FPCB1 and the first digitizer DGT1. The conductive film ACF2 may be an anisotropic conductive film, but is not particularly limited thereto. For example, the connecting circuit film FPCB1 and the conductive layer of the first digitizer DGT1 may be directly electrically connected with each other.

The main part DG-M of the second digitizer DGT2 may be electrically connected with the connecting circuit film FPCB1 through the connecting part DG-C and the first digitizer DGT1. That is, the connecting circuit film FPCB1 may transfer signals to the first digitizer DGT1 and the second digitizer DGT2, and may receive signals from the first digitizer DGT1 and the second digitizer DGT2.

The first digitizer DGT1 may include a plurality of first pads PD1 electrically connected to the connecting circuit film FPCB1, and the second digitizer DGT2 may include a plurality of second pads PD2 electrically connected to the first digitizer DGT1.

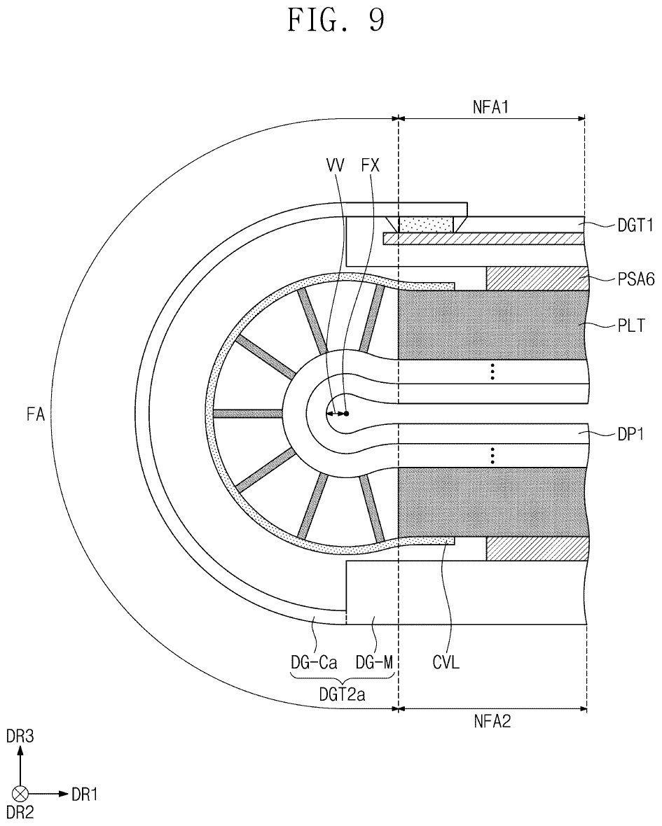

In one or more embodiments of the present disclosure, both the extension direction of a folding axis FX (refer to FIG. 9) of the display panel DP1 and the arrangement direction of the second pads PD2 may be substantially the same as the second direction DR2. The arrangement direction of the first pads PD1 may cross the arrangement direction of the second pads PD2. For example, the arrangement direction of the first pads PD1 may be the first direction DR1.

The electronic device 1000 may further include the bridge circuit film FPCB2 electrically connected to the connecting circuit film FPCB1. In addition, the electronic device 1000 may further include a first connector CNT1 located at one end of the bridge circuit film FPCB2, and connected with the connecting circuit film FPCB1 and a second connector CNT2 located at an opposite end of the bridge circuit film FPCB2.

According to one or more embodiments of the present disclosure, the first digitizer DGT1 and the second digitizer DGT2 separated from each other may be directly connected with each other. That is, a separate component for connecting the first digitizer DGT1 and the second digitizer DGT2 may be omitted. In addition, the second digitizer DGT2 may transmit or receive signals through one connecting circuit film FPCB1 connected to the first digitizer DGT1. That is, a connecting circuit film connected to the second digitizer DGT2 may be omitted. Because the component is able to be omitted, the manufacturing cost of the electronic device 1000 may be reduced, and the space in the set may be easily secured.

In addition, because signals are able to be transmitted to or received from the first and second digitizers DGT1 and DGT2 through the one connecting circuit film FPCB1, the shape of the bridge circuit film FPCB2 connected to the one connecting circuit film FPCB1 may be simplified, or the size of the bridge circuit film FPCB2 may be reduced. Accordingly, the number of outputs of the bridge circuit film FPCB2 may be increased. Thus, the manufacturing yield of the bridge circuit film FPCB2 may be improved, and the manufacturing cost may be reduced.

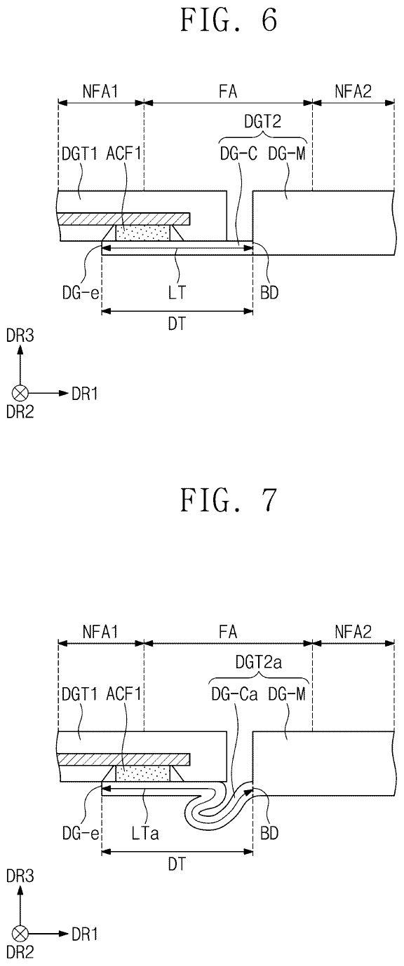

FIG. 6 is a sectional view of a portion of the digitizer according to one or more embodiments of the present disclosure.

Referring to FIGS. 2 and 6, a portion of the first digitizer DGT1 and a portion of the second digitizer DGT2 in a first state in which the folding area FA of the display panel DP has a flat shape are illustrated.

The first digitizer DGT1 may overlap the first non-folding area NFA1. The main part DG-M of the second digitizer DGT2 may overlap the second non-folding area NFA2. The connecting part DG-C may overlap the folding area FA and the first non-folding area NFA1. In addition, the first digitizer DGT1 may overlap at least one portion of the folding area FA. The main part DG-M may overlap at least one other portion of the folding area FA.

The first digitizer DGT1 and the main part DG-M of the second digitizer DGT2 are spaced apart from each other in the first direction DR1. The length LT between an edge DG-e of the connecting part DG-C and the boundary BD between the main part DG-M and the connecting part DG-C (e.g., a length of the connecting part DG-C) may be greater than or equal to the distance DT between the boundary BD and the edge DG-e. The length LT between the boundary BD and the edge DG-e may correspond to the actual length of the connecting part DG-C when viewed in a section (e.g., cross-section) defined by the first direction DR1 and the third direction DR3. The distance DT between the boundary BD and the edge DG-e may correspond to the distance parallel to the first direction DR1 when viewed in the third direction DR3. For example, the distance DT between the boundary BD and the edge DG-e may correspond to the width of an orthogonal projection in the first direction DR1 when the connecting part DG-C is orthogonally projected onto a plane defined by the first direction DR1 and the second direction DR2.

FIG. 7 is a sectional view of a portion of a digitizer according to one or more embodiments of the present disclosure. In describing FIG. 7, components identical to the components described with reference to FIG. 6 will be assigned with the identical reference numerals, and descriptions thereabout will be omitted.

Referring to FIGS. 2 and 7, a portion of a first digitizer DGT1 and a portion of a second digitizer DGT2a in the first state in which the folding area FA of the display panel DP has a flat shape are illustrated.

The first digitizer DGT1 and a main part DG-M of the second digitizer DGT2a are spaced apart from each other in the first direction DR1. The length LTa between an edge DG-e of the connecting part DG-Ca and the boundary BD, which is between the main part DG-M and a connecting part DG-Ca, may be greater than the distance DT between the boundary BD and the edge DG-e.

According to one or more embodiments of the present disclosure, the connecting part DG-Ca may be designed to have a length that is longer than the length suitable for the connecting part DG-Ca to be coupled to the first digitizer DGT1. In this case, at least a portion of the connecting part DG-Ca may have a curved shape in the first state in which the display panel DP is flat.

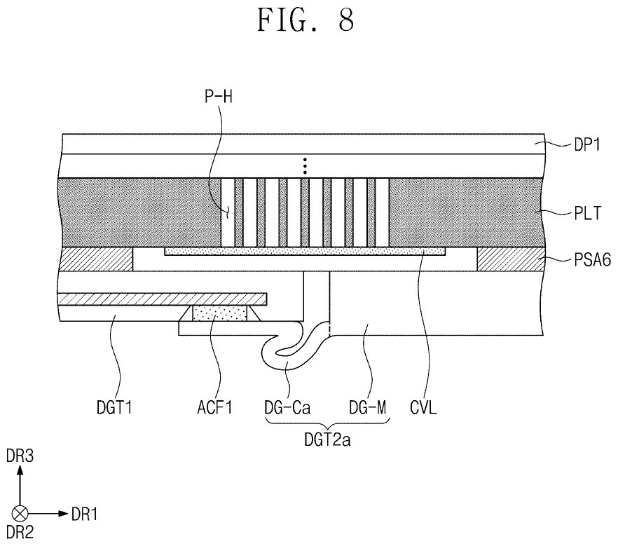

FIG. 8 is a sectional view illustrating some components of the electronic device in a state in which the display panel is flat according to one or more embodiments of the present disclosure. FIG. 9 is a sectional view illustrating some components of the electronic device in a state in which the display panel is folded according to one or more embodiments of the present disclosure.

In FIG. 8, the display panel DP1, the plate PLT, the cover layer CVL, the first digitizer DGT1, and the second digitizer DGT2 in the first state, in which the folding area FA of the display panel DP1 has a flat shape, are illustrated. In FIG. 9, the display panel DP1, the plate PLT, the cover layer CVL, the first digitizer DGT1, and the second digitizer DGT2 in the second state, in which the folding area FA of the display panel DP1 is folded, are illustrated.

Referring to FIGS. 7, 8, and 9, the display panel DP1 may be folded about the folding axis FX parallel to the second direction DR2. The folding area FA has a corresponding curvature and a corresponding radius of curvature VV. The distance between the first non-folding area NFA1 and the second non-folding area NFA2 may be less than or equal to twice the radius of curvature VV. For example, the distance between the first non-folding area NFA1 and the second non-folding area NFA2 of the display panel DP1 in the folded state may be less than twice the radius of curvature VV. Accordingly, in the folded state, the separation distance between the first non-folding area NFA1 and the second non-folding area NFA2 may be decreased. Thus, the electronic device 1000 (refer to FIG. 1A) having a slim state when folded may be provided.

According to one or more embodiments of the present disclosure, because the length of the connecting part DG-Ca is designed to have a relatively wide margin, stress and strain applied to the connecting part DG-Ca may be reduced or minimized even though the display panel DP1 is changed from the first state to the second state. Accordingly, damage to the connecting part DG-Ca may be reduced even though folding and unfolding operations are repeated. Thus, the electronic device 1000 with improved folding reliability may be provided.

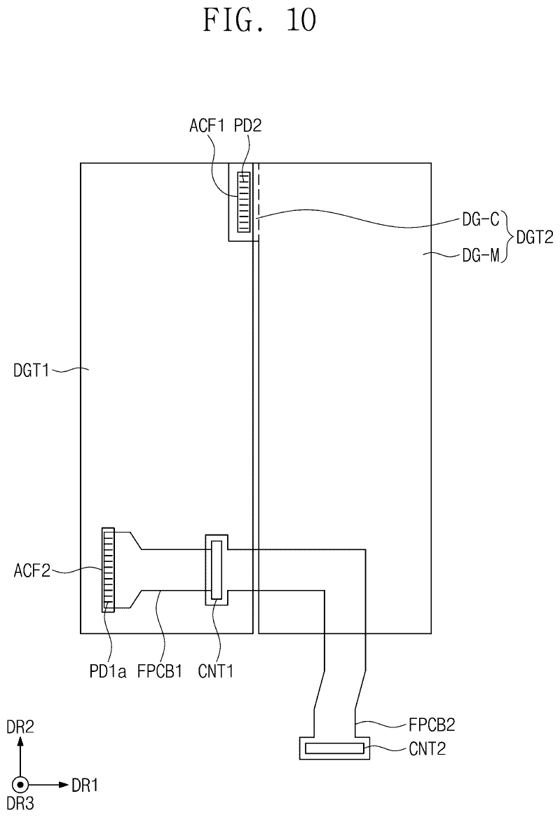

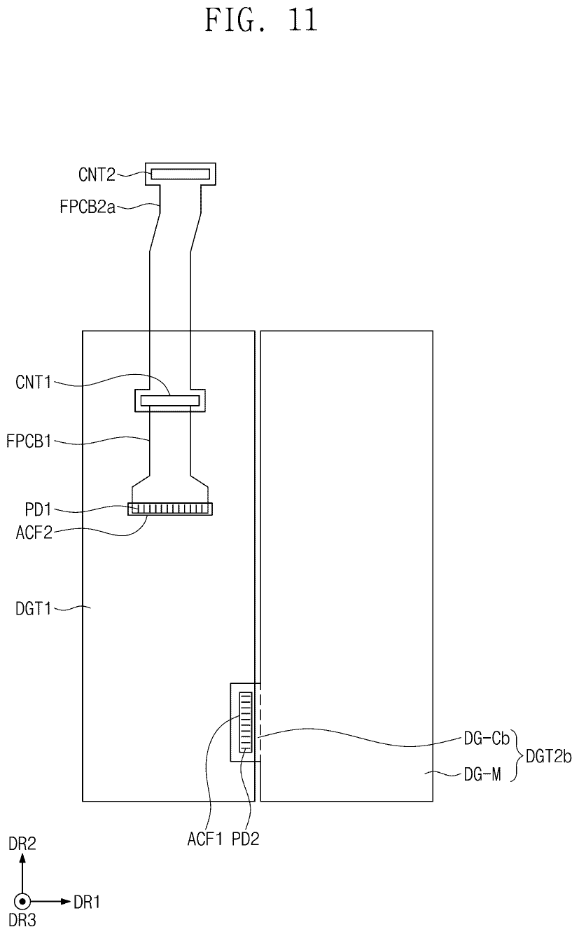

FIG. 10 is a view illustrating some components of the electronic device according to one or more embodiments of the present disclosure. FIG. 11 is a view illustrating some components of the electronic device according to one or more embodiments of the present disclosure. In describing FIGS. 10 and 11, components identical to the components described with reference to FIG. 5 will be assigned with the identical reference numerals, and descriptions thereabout will be omitted.

Referring to FIG. 10, a first digitizer DGT1, a second digitizer DGT2, a connecting circuit film FPCB1, and a bridge circuit film FPCB2 are illustrated.

The first digitizer DGT1 may include a plurality of first pads PD1a electrically connected to the connecting circuit film FPCB1, and the second digitizer DGT2 may include a plurality of second pads PD2 electrically connected to the first digitizer DGT1.

In one or more embodiments of the present disclosure, both the extension direction of the folding axis FX (refer to FIG. 9) of the display panel DP1 and the arrangement direction of the second pads PD2 may be substantially the same as the second direction DR2. The arrangement direction of the first pads PD1a may be substantially the same as the arrangement direction of the second pads PD2. For example, the arrangement direction of the first pads PD1a may be the second direction DR2. In this case, a process of pressing a connecting film ACF1 and a conductive film ACF2 may be simplified or facilitated because the first pads PD1a and the second pads PD2 located in pressed areas have the same arrangement direction.

Referring to FIG. 11, a first digitizer DGT1, a second digitizer DGT2b, a connecting circuit film FPCB1, and a bridge circuit film FPCB2a are illustrated.

The second digitizer DGT2b may include a main part DG-M and a connecting part DG-Cb. The connecting part DG-Cb may protrude from the main part DG-M to overlap the first digitizer DGT1. In one or more embodiments of the present disclosure, the connecting part DG-Cb may protrude from one side of the main part DG-M that extends in the second direction DR2. Accordingly, the connecting part DG-Cb may be spaced apart from sides of the main part DG-M that extend in the first direction DR1. The bridge circuit film FPCB2a may have a bar shape extending in one direction. That is, the shape of the bridge circuit film FPCB2a may be simplified.

Referring to FIGS. 10 and 11, the first digitizer DGT1 and the second digitizer DGT2 or DGT2b separated from each other may be directly connected with each other. That is, a separate component for connecting the first digitizer DGT1 and the second digitizer DGT2 or DGT2b may be omitted. In addition, the second digitizer DGT2 or DGT2b may transmit or receive signals through one connecting circuit film FPCB1 connected to the first digitizer DGT1. That is, a connecting circuit film connected to the second digitizer DGT2 or DGT2b may be omitted. Because the component is able to be omitted, the manufacturing cost of the electronic device 1000 may be reduced, and the space in the set may be easily secured.

In addition, because signals are able to be transmitted to or received from the first and second digitizers DGT1 and DGT2 or DGT2b through the one connecting circuit film FPCB1, the shape of the bridge circuit film FPCB2 or FPCB2a connected to the one connecting circuit film FPCB1 may be simplified, or the size of the bridge circuit film FPCB2 or FPCB2a may be reduced. Accordingly, the number of outputs of the bridge circuit film FPCB2 or FPCB2a may be increased. Thus, the manufacturing yield of the bridge circuit film FPCB2 or FPCB2a may be improved, and the manufacturing cost may be reduced.

As described above, the first digitizer and the second digitizer separated from each other may be directly connected with each other. That is, a separate component for connecting the first digitizer and the second digitizer may be omitted. In addition, the second digitizer may transmit or receive signals through one connecting circuit film connected to the first digitizer. That is, a connecting circuit film connected to the second digitizer may be omitted. Because the component is able to be omitted, the manufacturing cost of the electronic device may be reduced, and the space in the set may be easily secured.

In addition, because signals are able to be transmitted to or received from the first and second digitizers through one connecting circuit film, the shape of the bridge circuit film connected to the one connecting circuit film may be simplified, or the size of the bridge circuit film may be reduced. Accordingly, the number of outputs of the bridge circuit film may be increased. Thus, the manufacturing yield of the bridge circuit film may be improved, and the manufacturing cost may be reduced.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device comprising:
a display panel;
a first digitizer under the display panel;
a second digitizer under the display panel, electrically connected to the first digitizer, and comprising a main part spaced apart from the first digitizer in a first direction, and a connecting part extending from the main part toward the first digitizer to overlap the first digitizer; and
a connecting circuit film under the first digitizer.

2. The electronic device of claim 1, wherein the display panel comprises a first non-folding area, a folding area, and a second non-folding area sequentially arranged in the first direction,
wherein the first digitizer overlaps the first non-folding area,
wherein the main part of the second digitizer overlaps the second non-folding area, and
wherein the connecting part overlaps the folding area and the first non-folding area.

3. The electronic device of claim 2, further comprising a connecting film comprising an anisotropic conductive film between the connecting part and the first digitizer for electrically connecting the first digitizer and the second digitizer.

4. The electronic device of claim 2, wherein, in a first state in which the folding area of the display panel has a flat shape, a length of the connecting part between an edge of the connecting part and a boundary between the main part and the connecting part is greater than or equal to a distance between the boundary and the edge in plan view.

5. The electronic device of claim 4, wherein at least a portion of the connecting part has a curved shape in the first state.

6. The electronic device of claim 4, wherein the distance is in a direction parallel to the first direction.

7. The electronic device of claim 1, further comprising a conductive film between the connecting circuit film and the first digitizer,
wherein the connecting circuit film is electrically connected with the first digitizer, and is electrically connected with the main part of the second digitizer, through the first digitizer and the connecting part.

8. The electronic device of claim 1, further comprising:
a bridge circuit film electrically connected to the connecting circuit film;
a first connector at one end of the bridge circuit film, and connected with the connecting circuit film; and
a second connector at an opposite end of the bridge circuit film.

9. The electronic device of claim 1, wherein the first digitizer comprises first pads electrically connected to the connecting circuit film, and
wherein the second digitizer comprises second pads electrically connected to the first digitizer.

10. The electronic device of claim 9, wherein an extension direction of a folding axis of the display panel is substantially the same as an arrangement direction of the second pads.

11. The electronic device of claim 9, wherein an arrangement direction of the first pads is substantially the same as an arrangement direction of the second pads.

12. The electronic device of claim 9, wherein an arrangement direction of the first pads crosses an arrangement direction of the second pads.

13. The electronic device of claim 1, wherein the first digitizer and the second digitizer are spaced apart from each other in the first direction, and
wherein a width of the connecting part in a second direction crossing the first direction is less than a width of the main part.

14. An electronic device comprising:
a display panel comprising a first non-folding area, a folding area, and a second non-folding area sequentially arranged in a first direction;
a first digitizer overlapping the first non-folding area and at least a portion of the folding area; and
a second digitizer comprising a main part overlapping the second non-folding area, and a connecting part extending from the main part and overlapping the first digitizer.

15. The electronic device of claim 14, wherein, in a first state in which the folding area of the display panel has a flat shape, a length of the connecting part between an edge of the connecting part and a boundary between the main part and the connecting part is greater than or equal to a distance in the first direction between the boundary and the edge.

16. The electronic device of claim 15, wherein at least a portion of the connecting part has a curved shape in the first state.

17. The electronic device of claim 14, further comprising a connecting circuit film coupled to the first digitizer,
wherein the first digitizer comprises first pads electrically connected to the connecting circuit film,
wherein the second digitizer is electrically connected to the connecting circuit film through the first digitizer, and comprises second pads electrically connected to the first digitizer, and
wherein an extension direction of a folding axis of the display panel is substantially the same as an arrangement direction of the second pads.

18. The electronic device of claim 17, wherein an arrangement direction of the first pads is substantially the same as the arrangement direction of the second pads.

19. The electronic device of claim 17, wherein an arrangement direction of the first pads crosses the arrangement direction of the second pads.

20. The electronic device of claim 17, further comprising:
a bridge circuit film electrically connected to the connecting circuit film;
a first connector at one end of the bridge circuit film, and connected with the connecting circuit film; and
a second connector at an opposite end of the bridge circuit film.

21. The electronic device of claim 1, wherein the electronic device comprises a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).
